(19) United States
(12) Patent Application Publication
(10) Pub. No.: US 2014/0291175 A1
(43) Pub. Date: Oct. 2, 2014

(54) Tablet Computer Cover and Stand

(71) Applicant: MARWARE, INC., Hollywood, FL (US)

(72) Inventors: Chanseol Chung, Hollywood, FL (US); Peter Solomon, Fort Lauderdale, FL (US)

(73) Assignee: Marware, Inc., Hollywood, FL (US)

(21) Appl. No.: 13/854,633

(22) Filed: Apr. 1, 2013

(51) Int. Cl. G06F 1/16

(52) U.S. Cl. CPC G06F 1/1656
USPC 206/45.23

(57) ABSTRACT

A tablet computer cover and stand includes a front cover and a rear cover interconnected by a cover hinge and configured to enclose a tablet computer therebetween in a closed condition. The front and rear covers have respective inner and outer surfaces and the inner surface of the front cover has an anti-slip surface. A shell is rotatable on the rear cover about a shell hinge and configured to hold the tablet computer. The shell has a free end configured to engage anywhere on the anti-slip surface upon opening the front and rear covers about the cover hinge and rotating the shell about the shell hinge from the closed condition to a standing position. The shell can be adjusted into infinitely variable positions for carrying out applications on the tablet computer and can be rotated between landscape and portrait orientations.

### BACKGROUND OF THE INVENTION

1. Field of the Invention

The invention relates to a tablet computer cover and stand, which is adjustable into different viewing angles and orientations.

2. Description of the Related Art

A tablet computer is a one-piece, mobile computer which typically has a touch screen. Tablet computers, such as the iPad®, are monolithic devices which, unlike laptop computers, require a stand to hold them in a comfortable position for viewing or typing. They also are subject to soiling, wear and damage due to shocks and therefore require covers for protection.

Many prior art devices provide such functions, but are generally only movable into two positions and therefore do not permit the tablet computer to be displayed in several different positions which are required for the many applications for which they are used, such as typing, watching videos and delivering presentations to a group.

### BRIEF SUMMARY OF THE INVENTION

It is accordingly an object of the invention to provide a tablet computer cover and stand, which overcomes the above-mentioned disadvantages of the heretofore-known devices of this general type and which permits a tablet computer to be displayed in several varied positions which are required for different applications.

With the foregoing and other objects in view there is provided, in accordance with the invention, a tablet computer cover and stand, comprising a front cover and a rear cover interconnected by a cover hinge and configured to enclose a tablet computer therebetween in a closed condition. The front and rear covers have respective inner and outer surfaces and the inner surface of the front cover has an anti-slip surface. A shell is rotatable on the rear cover about a shell hinge and configured to hold the tablet computer. The shell has a free end configured to engage anywhere on the anti-slip surface upon opening the front and rear covers about the cover hinge and rotating the shell about the shell hinge from the closed condition to a standing position. Thus, according to the invention, the computer may be protected against damage and soiling and may be displayed at different viewing angles by using one and the same cover and stand.

In accordance with another feature of the invention, a stand pad has the anti-slip surface disposed thereon, the stand pad is configured to be rotated on the front cover between a folded position and an extended position for engagement of the free end of the shell anywhere along the anti-slip surface relatively closer to the cover hinge in the folded position and relatively farther away from the cover hinge in the extended position.

The anti-slip surface, whether used with or without the stand pad, provides an infinitely adjustable viewing angle of the tablet computer, for example substantially between 90° and 60°, by moving the free end of the shell along the anti-slip surface.

In accordance with a further feature of the invention, a pivot interconnects the rear cover and the shell and the shell rotates about the pivot on the rear cover between a landscape and a portrait orientation of the tablet computer held in the shell. A pin is connected to the rear cover and passes through a curved slot in the shell for guiding the rotation of the shell. A connector interconnects the shell and the rear cover in the landscape and portrait orientations. The pivot and the pin may be respective rivets and the connector may be a snap. This configuration makes rotation between landscape and portrait orientations and locking in those orientations particularly easy and reliable.

In accordance with an added feature of the invention, the shell hinge has one leaf fastened to the rear cover and another leaf connected to the shell by the rivets. Such a hinge permits full rotation of the shell and rear cover as well as anchoring for the rivets.

In accordance with a concomitant feature of the invention, hooks are disposed on one of the covers, straps are spring-loaded for retraction into the other of the covers and a closure tab is attached to the straps and configured to be engaged behind the hooks for locking the computer cover and stand in the closed condition. This construction provides security against the cover accidentally opening and being susceptible to damage and soiling.

Other features which are considered as characteristic for the invention are set forth in the appended claims.

Although the invention is illustrated and described herein as embodied in a tablet computer cover and stand, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIGS. 1 and 2 are diagrammatic, front-elevational and side-elevational views respectively showing a tablet computer cover and stand according to the invention, in a closed condition with a shell for holding a tablet computer disposed therein;

FIG. 3 is a top-plan view showing the inside of the cover and stand in an open condition with the shell for holding the computer in the portrait orientation;

FIG. 4 is a front-perspective view of the cover and stand in the closed condition;

FIGS. 5 and 6 are front-perspective views showing the operation of a closure tab of the cover and stand;

FIGS. 7 and 8 are top-plan and side-elevational views respectively showing the inside of the cover and stand in the open condition with the shell in the landscape orientation;

FIGS. 9 and 10 are top-perspective and side-elevational views respectively showing the shell being unsnapped and lifted from the rear cover;

FIG. 11 is a bottom-perspective view illustrating how the shell is connected to the cover;

FIGS. 12 and 13 are side-perspective and side-elevational views respectively showing the cover and stand in a standing position with the shell in the portrait orientation;

FIGS. 14 and 15 are side-perspective and side-elevational views respectively showing the cover and stand in the standing position with the shell in the landscape orientation;

FIGS. 16 and 17 are side-perspective and side-elevational views respectively showing the cover and stand in the standing position with a stand pad in a partially opened position; and

FIGS. 18 and 19 are side-perspective and side-elevational views respectively showing the cover and stand in the standing position with the stand pad fully extended.

### DETAILED DESCRIPTION OF THE INVENTION

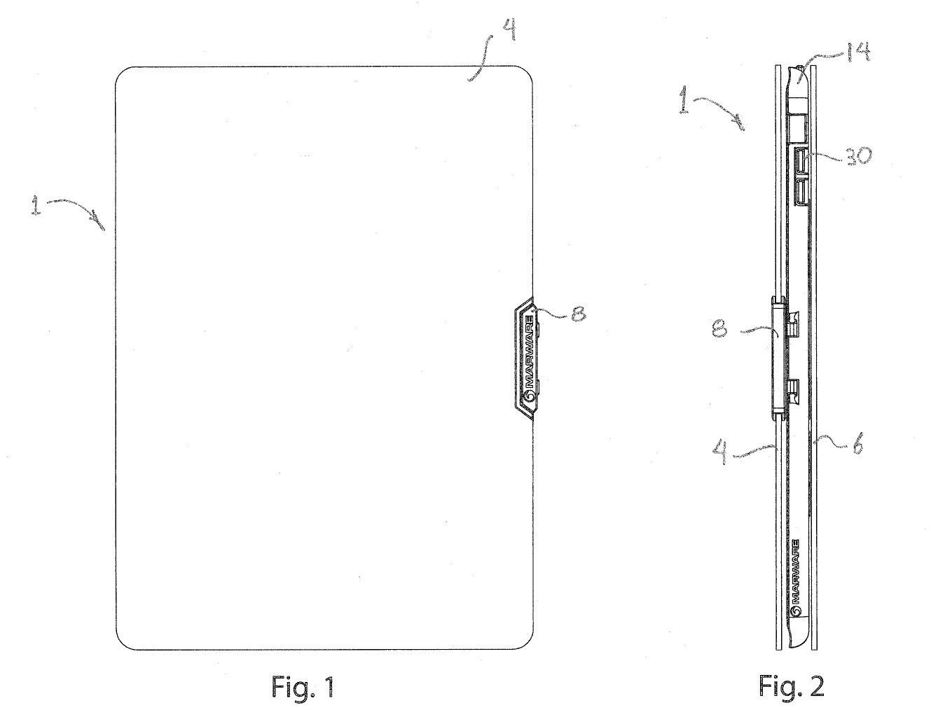

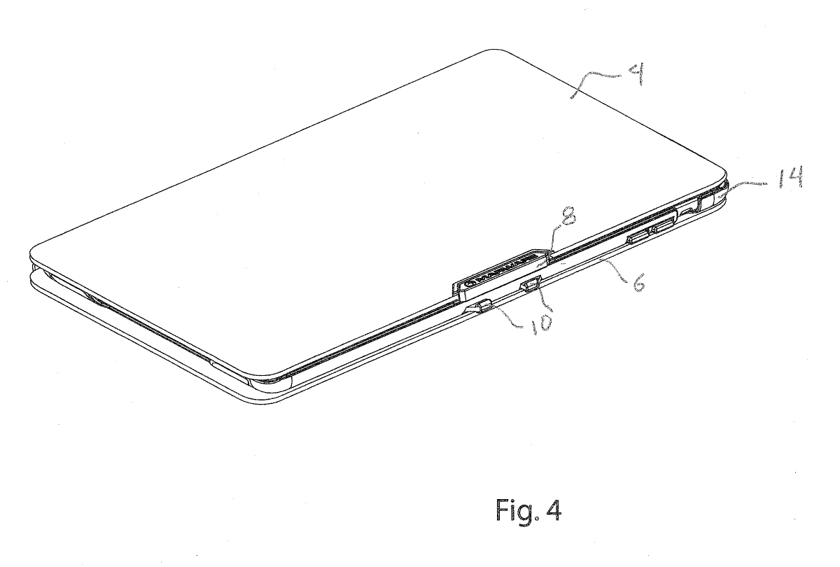

Referring now to the figures of the drawing in detail and first, particularly, to FIGS. 1, 2 and 4 thereof, there is seen a tablet computer cover and stand 1 in a closed condition. The cover and stand 1 includes a front folio cover 4 and a rear folio cover 6 surrounding a shell 14 which holds a tablet computer 30 in such a way that only USB ports of the computer 30 can be seen. A closure tab 8 for locking the covers 4, 6 together is shown in a retracted and open position in FIG. 4, in which it is released from hooks 10.

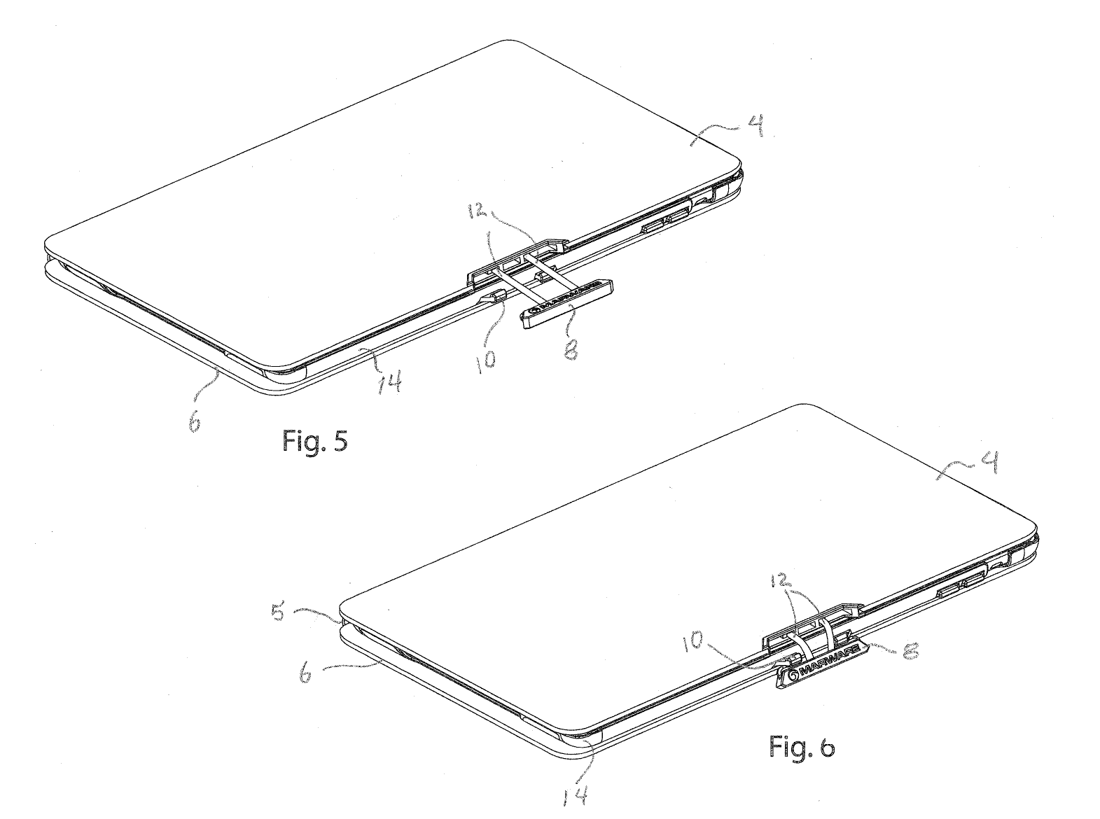

FIGS. 5 and 6 show that the closure tab 8 is attached to straps 12 which are guided through slots in the front folio cover 4 and are spring-loaded to pull the straps and therefore the closure tab 8 towards the front folio cover 4. The closure tab 8 is operated by pulling the closure tab 8 and extracting the straps 12 as shown in FIG. 5 and locking the closure tab 8 below the hooks 10 as shown in FIG. 6.

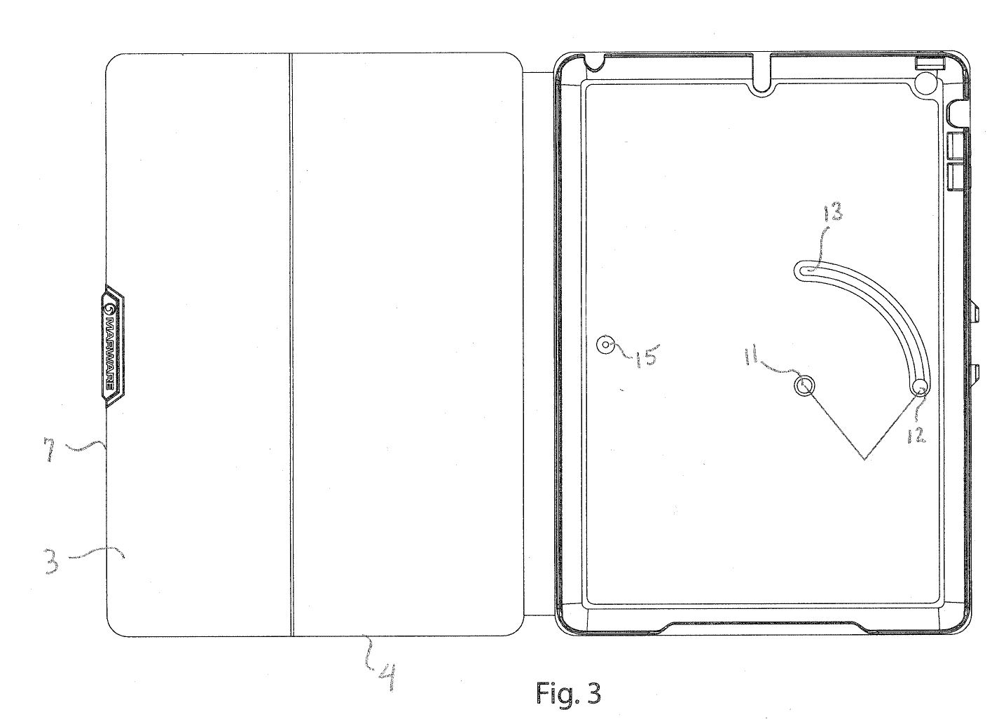

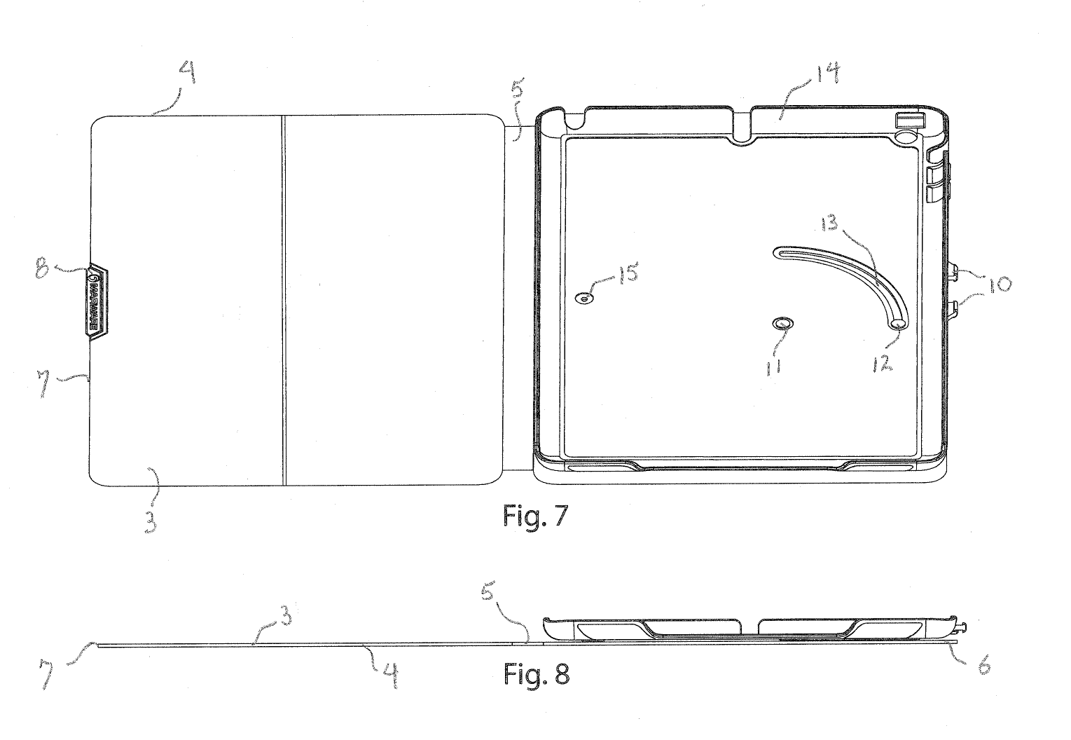

FIGS. 3, 7 and 8 show the cover and stand 1 in an open condition, from which it can be seen that the front and rear covers 4, 6 are interconnected by a living cover hinge 5 and that the shell 14 for holding the tablet computer 30 is connected to the rear folio cover 6 by rivets 11, 12 and a snap 15. The side of the shell 14 adjacent the living hinge 5 may be lifted to open the snap 15, which permits the shell 14 to be rotated about the rivet 11 with the rivet 12 sliding in a curved slot 13. In this way, the shell 14 can be rotated between the portrait orientation shown in FIG. 3 and the landscape orientation shown in FIGS. 7 and 8. The snap 15 may be closed in both orientations to securely hold the shell 14 in place. Of course, any type of pivot may be used instead of the rivet 11, any type of pin may be used instead of the pivot 12 and any type of connector may be use instead of the snap 15.

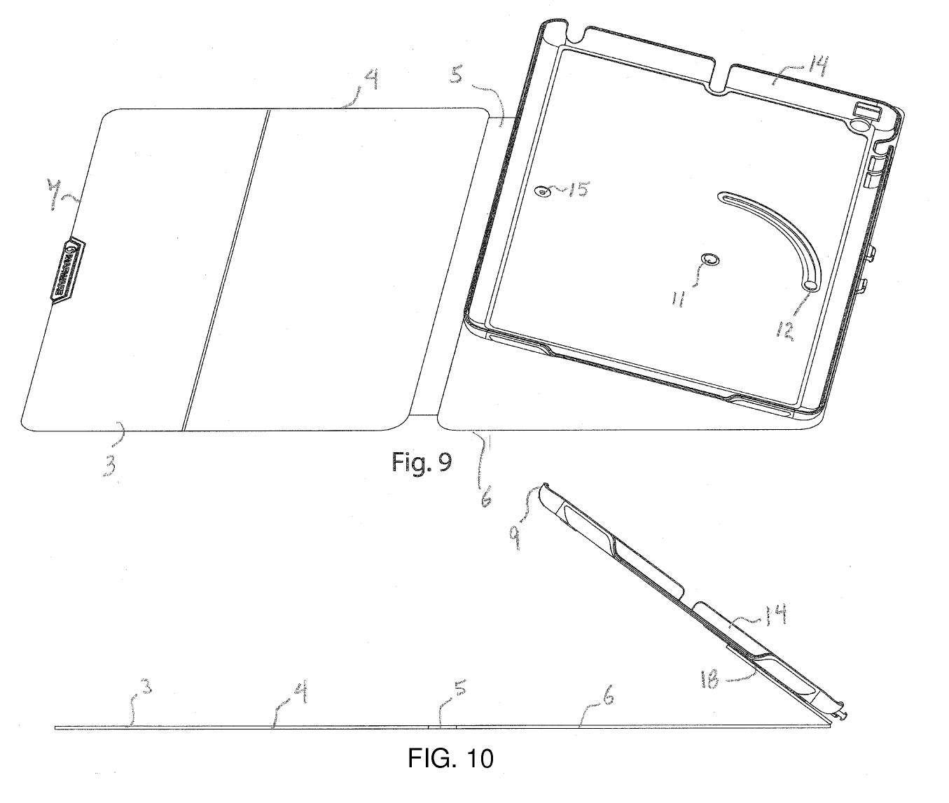

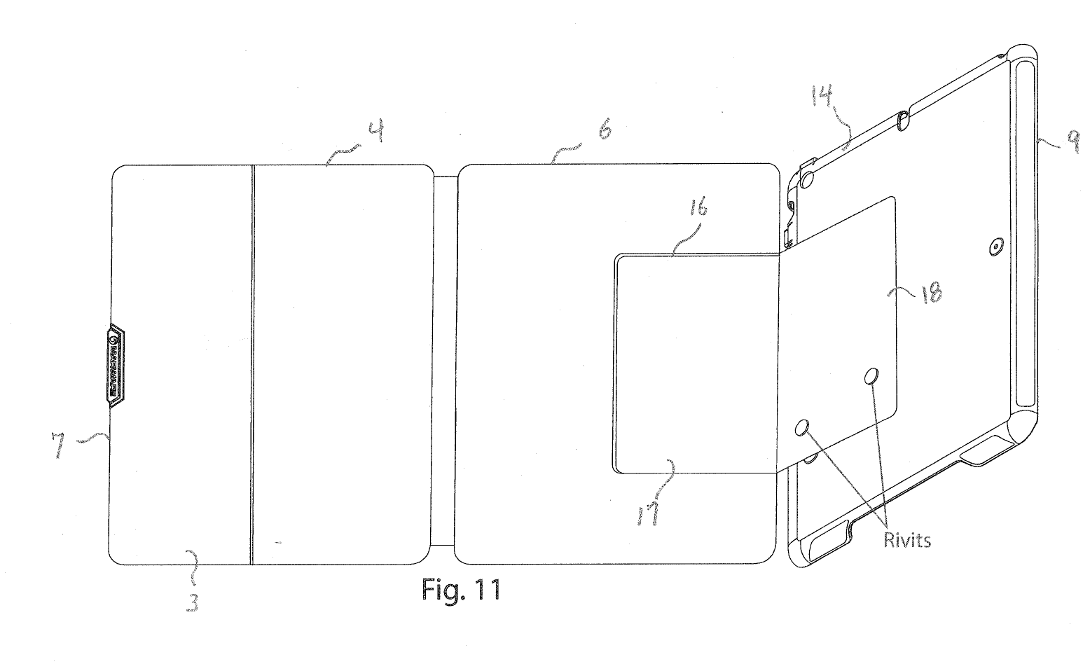

FIG. 9 shows the shell 14 being unsnapped and lifted from the rear cover 6. The side view of FIG. 10 and the rear view of FIG. 11 illustrate how the rear cover 6 and the shell 14 are interconnected by a hinge 16 which is hidden in FIG. 9. The hinge 16 has one leaf or wing 17 which is fastened to the rear cover 6 and another leaf or wing 18 which is connected to the shell 14 by the rivets 11, 12. In FIG. 11, the shell has been rotated so far that the snap 15 is far from the rear cover 6.

FIGS. 3 and 7-11 also show that a stand pad 3, which is covered on both sides with rubbery, anti-slip material, is rotatable about an outer edge 7 of the inner surface of the front cover 4 facing away from the hinge 5, between a folded and an extended position.

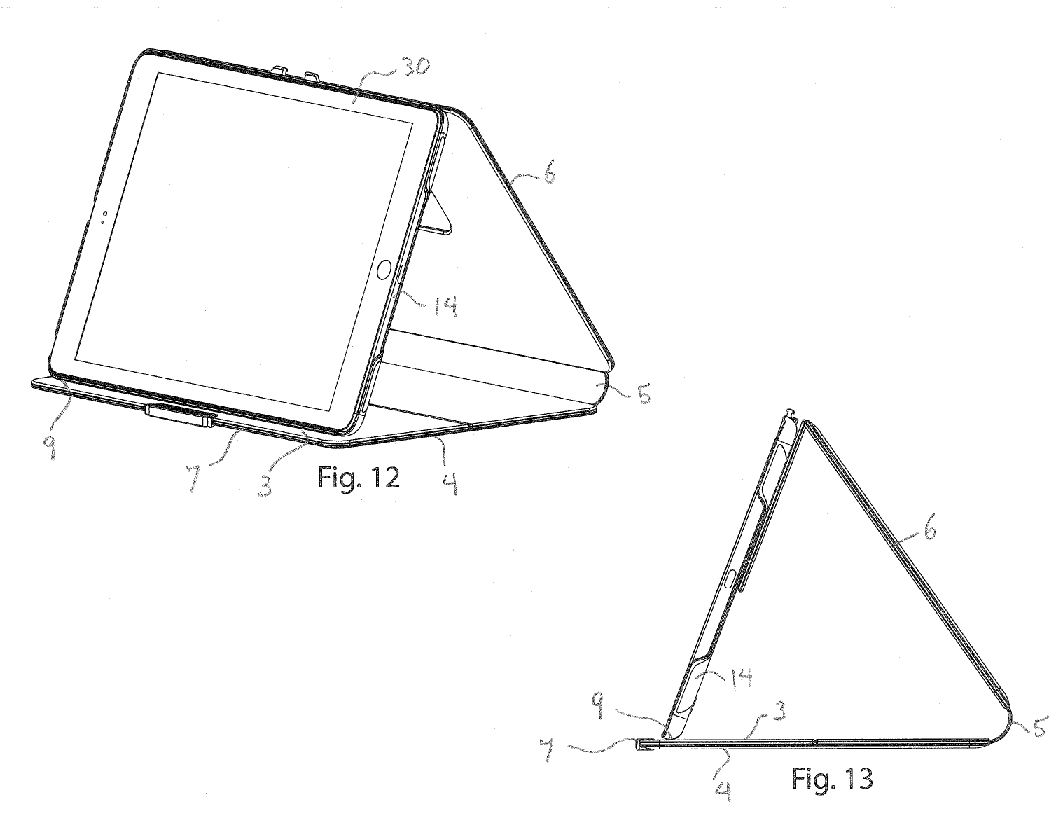

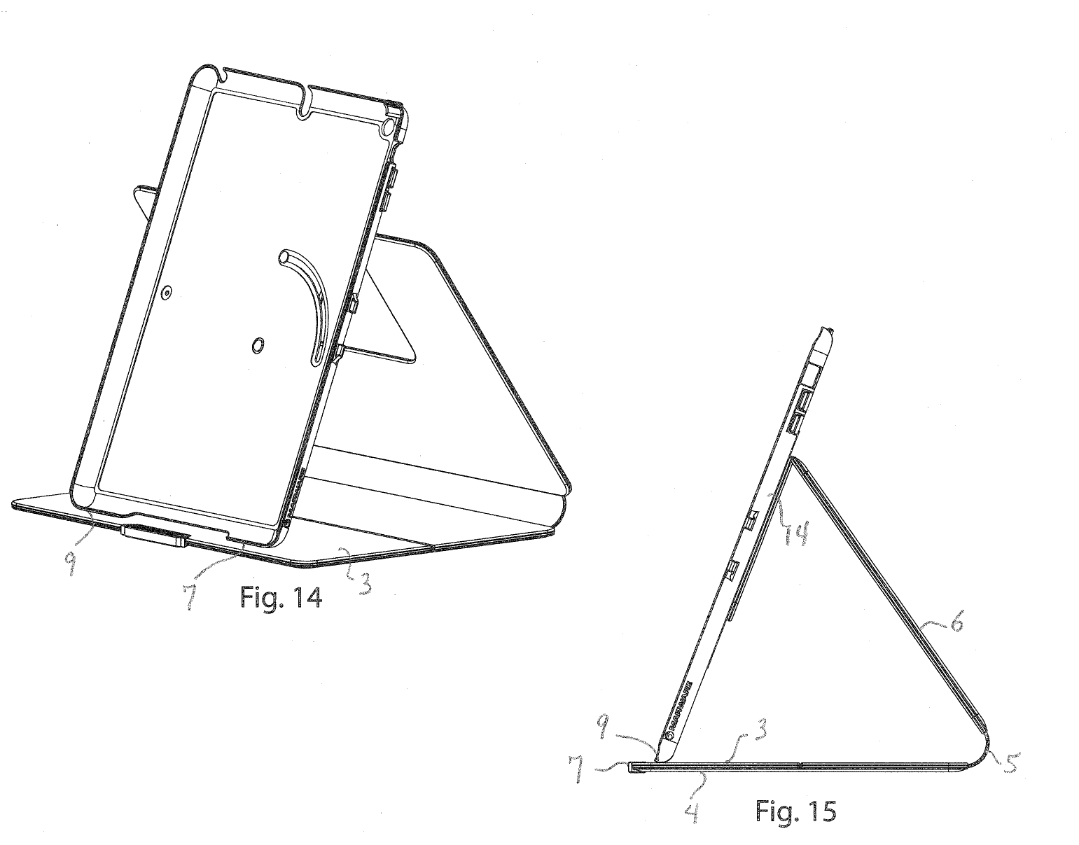

FIGS. 12 and 13 show the cover and stand 1 rotated from the position shown in FIG. 10 about the living or live hinge 5, until a free end 9 of the shell 14 facing away from the rear cover 6 rests on the stand pad 3, which is in a folded position lying on the front cover 4. The cover and stand 1 is then in a standing position with the shell 14 in the portrait orientation. FIGS. 14 and 15 also show the cover and stand in the standing position, but with the shell 14 in the landscape orientation.

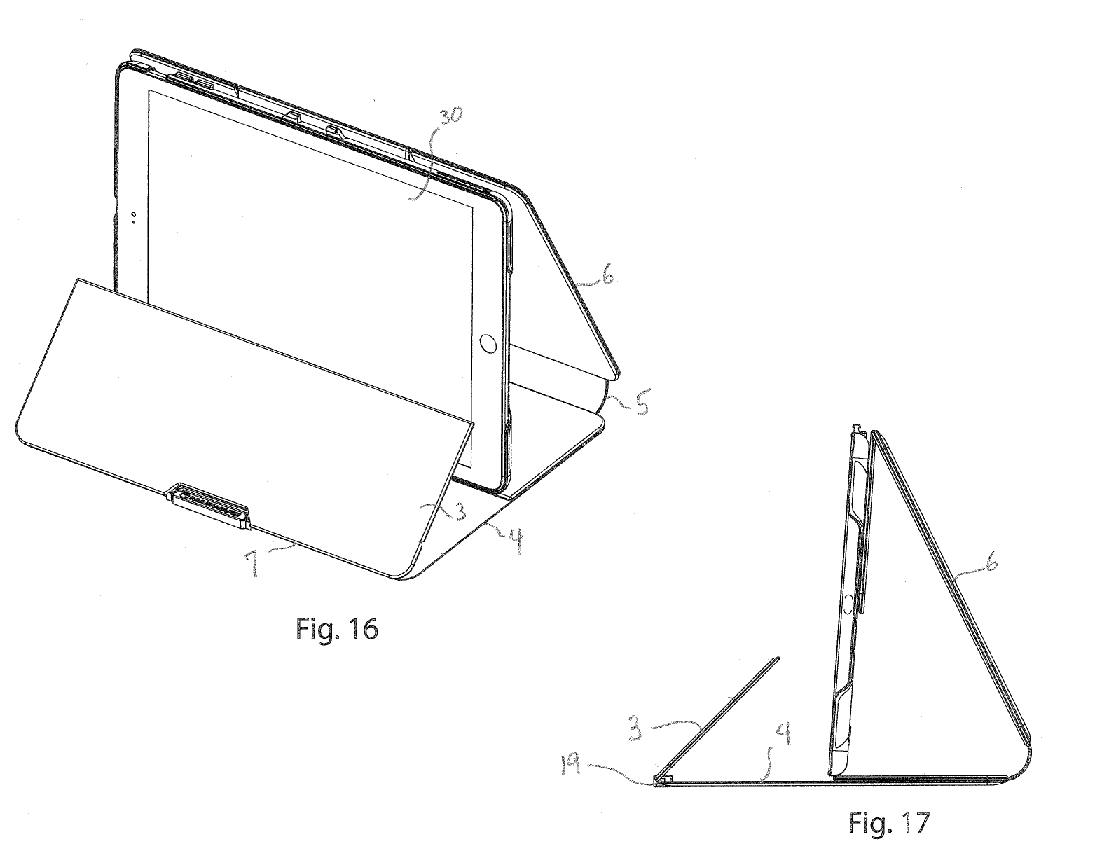

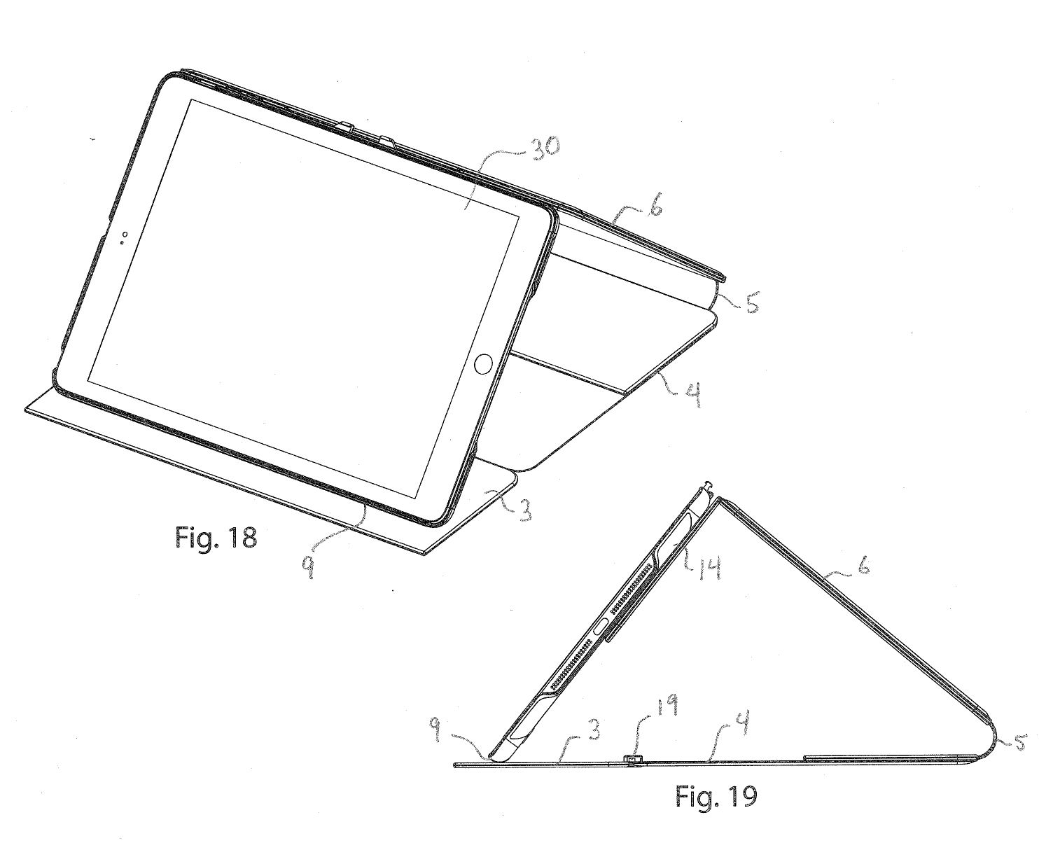

FIGS. 16 and 17 show the cover and stand 1 in the standing position with the stand pad 3 rotated about a shell hinge 19 into a partially opened and extended position. According to FIGS. 18 and 19, the stand pad 3 has been rotated further about the hinge 19 into a fully extended position so that the free end 9 of the shell 14 may be placed on the stand pad 3 further away from hinge 5. Thus, the viewing angle of the tablet computer can be infinitely varied substantially between a 90° angle shown in FIGS. 16 and 17 and a 60° angle shown in FIGS. 18 and 19.

1. A tablet computer cover and stand, comprising:
a front cover and a rear cover interconnected by a cover hinge and configured to enclose a tablet computer therebetween in a closed condition, said front and rear covers having respective inner and outer surfaces and said inner surface of said front cover having an anti-slip surface; and
a shell rotatable on said rear cover about a shell hinge and configured to hold the tablet computer, said shell having a free end configured to engage anywhere on said anti-slip surface upon opening said front and rear covers about said cover hinge and rotating said shell about said shell hinge from said closed condition to a standing position.

2. The tablet computer cover and stand according to claim 1, wherein said anti-slip surface provides an infinitely adjustable viewing angle of the tablet computer by moving said free end of said shell along said anti-slip surface.

3. The tablet computer cover and stand according to claim 2, wherein said viewing angle is infinitely adjustable substantially between 90° and 60°.

4. The tablet computer cover and stand according to claim 1, which further comprises a stand pad having said anti-slip surface disposed thereon, said stand pad configured to be rotated on said front cover between a folded position and an extended position for engagement of said free end of said shell anywhere along said anti-slip surface relatively closer to said cover hinge in said folded position and relatively farther away from said cover hinge in said extended position.

5. The tablet computer cover and stand according to claim 4, wherein said anti-slip surface provides an infinitely adjustable viewing angle of the tablet computer by moving said free end of said shell along said anti-slip surface.

6. The tablet computer cover and stand according to claim 5, wherein said viewing angle is infinitely adjustable substantially between 90° and 60°.

7. The tablet computer cover and stand according to claim 1, which further comprises a pivot interconnecting said rear cover and said shell and about which said shell rotates on said rear cover between a landscape and a portrait orientation of the tablet computer held in said shell.

8. The tablet computer cover and stand according to claim 7, which further comprises a pin connected to said rear cover and passing through a curved slot in said shell for guiding said rotation of said shell.

9. The tablet computer cover and stand according to claim 8, which further comprises a connector interconnecting said shell and said rear cover in said landscape and portrait orientations.

10. The tablet computer cover and stand according to claim 9, wherein said pivot and said pin are respective rivets and said connector is a snap.

11. The tablet computer cover and stand according to claim 10, wherein said shell hinge has one leaf fastened to said rear cover and another leaf connected to said shell by said rivets.

12. The tablet computer cover and stand according to claim 1, which further comprises hooks disposed on one of said covers, straps spring-loaded for retraction into the other of said covers and a closure tab attached to said straps and configured to be engaged behind said hooks for locking the computer cover and stand in said closed condition.
